(19) United States
(12) Patent Application Publication
(10) Pub. No.: US 2014/0000297 A1
(43) Pub. Date: Jan. 2, 2014

(54) Production of Particles from Liquids or Suspensions with Liquid Cryogens

(71) Applicant: Rolf Helmut WIELAND, Gilbertsville, PA (US)

(72) Inventor: Rolf Helmut WIELAND, Gilbertsville, PA (US)

(73) Assignee: Air Liquide Industrial U.S. L.P., Houston, TX (US)

(21) Appl. No.: 13/538,061

(22) Filed: Jun. 29, 2012

(51) Int. Cl. B01J 2/06; A23D 9/05; F25C 1/00

(52) U.S. Cl. CPC B01J 2/06; F25C 1/00; A23D 9/05
USPC 62/64; 62/373

(57) ABSTRACT

A liquid or suspension is formed into frozen particles through contact of a diverging cone spray of the liquid or suspension with a converging cone spray of a liquid cryogen. The converging cone spray of the liquid cryogen is sprayed from a converging annulus defined by an outer surface of an atomization nozzle and an inner surface of a liquid cryogen housing surrounding the atomization nozzle.

### CROSS-REFERENCE TO RELATED APPLICATIONS

None.

### BACKGROUND

The invention relates to a method and apparatus for converting liquids or suspensions into particulate materials such as powders, crystals, pellets, or granules useful in the compounding of pharmaceuticals, cosmetics, and foods.

It is known to produce particulate material by spraying the liquid or suspensions into a cooling chamber where the spray is contacted with a spray of liquid nitrogen or liquid carbon dioxide. Such methods are sometimes termed cryo-crystallization, despite the fact that some of the applications do not necessarily produce particles containing crystalline materials. The liquids or suspensions range from edible or non-edible oils or fats, aqueous solutions of biological materials, and cosmetic or pharmaceutical additives.

Several proposals for producing the above particulate materials are found in the patent literature, including GB 1559920, WO 12041682, U.S. Pat. Nos. 4,952,224, 5,475,984, 4,488,407, EP 2353400, US 2012052102, US 2011067417, US 2003064141, and US 2001038872. To the extent that a specific structure for achieving the two sprays is described and illustrated, the patent literature suggests spraying one fluid in a central spray and spraying the other fluid from a plurality of nozzles formed in a ring that encircles the central spray. Alternatively, the other fluid is sprayed from two nozzles to the sides of the central spray.

However, the above proposals in the patent literature yield some disadvantages. In particular, the size distribution of the material being formed into particles is often too non-uniform. Also, the fixed manner in which the two sprays are produced and contacted with one another makes it difficult to make adjustments in the manner in which the two sprays contact one another. More particularly, if a different spray shape is desired or if the point at which the two sprays contact one another needs to be changed, the cryo-crystallization apparatus typically needs to be disassembled and new nozzles installed.

Thus, there is a need to improve the uniformity of particle size distribution produced by the cryo-crystallization process. There is also a need to provide a cryo-crystallization apparatus that allows changes in the manner in which the two sprays contact one another that does not need to be disassembled and fitted with new nozzles.

### SUMMARY

There is provided a method of producing particles from a liquid or suspension, said method comprising the steps of: spraying the liquid or suspension from an atomization nozzle into a collection chamber as a diverging cone; and spraying liquid cryogen from a continuous, converging annulus into the collection chamber as a converging cone. The diverging cone and the converging cone meet at a ring-shaped intersection where droplets of the sprayed liquid are frozen into particles through heat exchange with the sprayed cryogen. The converging annulus is defined by the outer surface of the atomization nozzle and an inner surface of a liquid cryogen housing surrounding the atomization nozzle.

There is also provided a system for producing particles from a liquid or suspension, comprising: an atomization nozzle; a liquid cryogen housing surrounding the atomization nozzle; and a collection chamber. The atomization nozzle has an upstream end, a downstream end, and a centrally disposed bore extending through an axis of the nozzle. The bore converges at the downstream end of the nozzle for allowing a flow of the liquid or suspension to be sprayed therefrom as a diverging cone with an angle α to the bore axis. The liquid cryogen housing has an upstream end and a downstream end, an outer surface of the atomization nozzle and an inner surface of the liquid cryogen housing defining a continuous annulus that converges towards the bore axis at the downstream end of the housing for allowing a flow of the liquid cryogen to be sprayed therefrom as a converging cone an angle β to the bore axis. The collection chamber is for collecting frozen particles of the liquid or suspension that are formed at the intersection of the converging and diverging cones. The downstream ends of the atomization nozzle and liquid cryogen housing fluidly communicate with an interior of the collection chamber.

The method of system may include one or more of the following aspects:
the liquid cryogen is nitrogen or carbon dioxide.
gaseous cryogen is exhausted from the collection chamber into a cyclone separator where any of the particles that may have been carried over with the exhausted cryogen are separated from the exhausted cryogen.
the frozen particles are collecting in a bottom portion of the collection chamber and a valve is periodically opened up to release the frozen particles from the collection chamber.
gaseous cryogen is exhausted from the collection chamber into a cyclone separator where any of the particles that may have been carried over with the exhausted cryogen are separated from the exhausted cryogen and the separated particles are collected at the bottom of the cyclone separator.
the liquid or suspension comprises a molten fat.
the liquid or suspension comprises an aqueous suspension of a biological material.
β-α ranges from 5° to about 40°.
the atomization nozzle further comprising an inner flange disposed at a circumferential surface thereof at the nozzle downstream end that has an outer diameter that decreases towards the nozzle downstream end at the angle α.
the liquid cryogen housing comprising a cylindrical tube concentric with the bore axis, a ring connected to the tube at the housing upstream end and to the outer surface of the atomization nozzle in fluid-tight fashion, and an outer flange disposed on an inner surface of the cylindrical tube adjacent the housing downstream end that is concentric with the bore axis and projects inwardly towards the inner flange, wherein:

an outer surface of the atomization nozzle is formed as a cylinder with an outer diameter that is constant from the nozzle upstream end to just upstream of the inner flange;

the cylindrical tube has a constant diameter from the ring to just upstream of the outer flange; and

the outer flange increasingly projects inwardly from upstream to downstream at the angle β.
the method or system further comprises a cyclone separator and an exhaust duct that fluidly communicates between an interior of the separator and an interior of the collection chamber for separating any frozen particles of the liquid or suspension that may have been carried over with exhausted cryogen to the separator from the collection chamber.
the method or system further comprises a tank of liquid cryogen and a container of the liquid or suspension to be frozen into particles.
the method or system further comprises a source of the liquid or suspension in fluid communication with the bore and a source of the liquid cryogen in fluid communication with the annulus.

### DETAILED DESCRIPTION

In order to achieve a more uniform size distribution of particles of a frozen liquid or suspension, liquid cryogen is sprayed in a converging cone form a continuous annulus that converges in the downstream direction. A liquid cryogen housing surrounds and cooperates with an atomization nozzle to form the converging, continuous annulus in between the housing and nozzle.

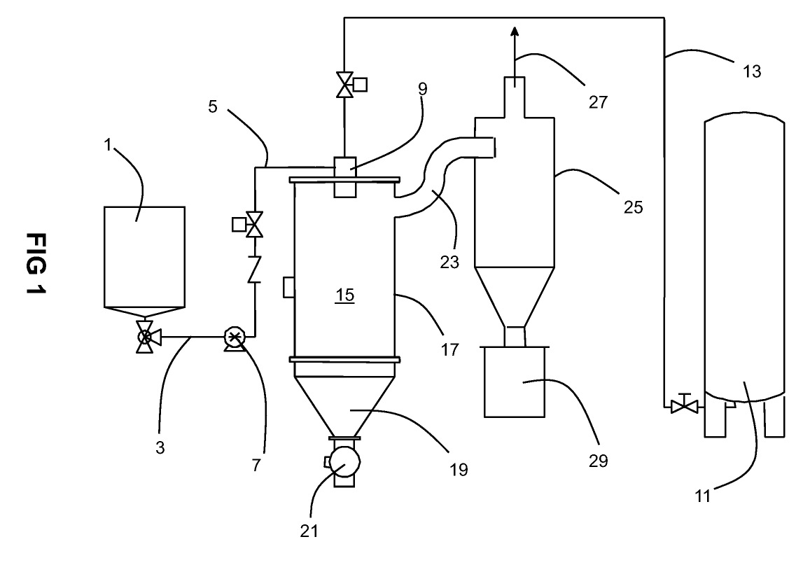

As best shown in FIG. 1, a system for producing particles of the liquid or suspension includes a container 1 of the liquid or suspension and that is pumped through lines 3, 5 with a pump 7 to a spraying device 9. The spraying device 9 is mounted at a top of a collection chamber 17. A liquid cryogen stored in tank 11 is conveyed through vacuum jacketed line 13 to the spraying device 9 under its own pressure.

The spraying device 9 sprays the liquid or suspension in the form of a diverging cone. A converging cone of liquid nitrogen sprayed from spraying device 9 intersects the diverging cone at a ring-shaped intersection where the liquid or suspension is frozen through heat exchange with the cryogen. The particles fall through an interior 15 of the collection chamber 17 to settle in a bottom portion 19 of the chamber 17. Periodically, an amount of the particles are removed from the bottom portion 19 via valve 21.

Because the liquid cryogen sprayed into the interior 15 of the chamber 17 vaporizes, the excess gas is exhausted through an exhaust duct 23 to the interior of a cyclone separator 25. As one of ordinary skill in the art will recognize, cyclone separators utilize a cyclonic flow of a gas inside a chamber. The higher momentum of any solid material entrained in the gas causes the solid material to collect on the chamber wall. The separated particles fall into a bottom portion 29 of the cyclone separator 25 where they are periodically removed and combined with particles removed from the collection chamber 17. The gaseous cryogen is exhausted from the separator 25 via vent 27.

The liquid cryogen is either liquid nitrogen or liquid carbon dioxide. As the liquid nitrogen exits the spraying device 9, it is formed as a converging cone of tiny droplets of liquid nitrogen together with gaseous nitrogen. As the droplets of liquid nitrogen and the gaseous nitrogen contact the warmer liquid or suspension being sprayed from the spraying device 9, the droplets absorb the heat of vaporization from the liquid or suspension and partially or wholly vaporize. The warmer liquid or suspension is also cooled through direct heat exchange with the cold gaseous nitrogen. On the other hand, as the liquid carbon dioxide exits the spraying device, it is formed as a converging cone of tiny particles of solid carbon dioxide together with gaseous carbon dioxide. As the particles of carbon dioxide and the gaseous carbon dioxide contact the liquid or suspension, the particles absorb the heat of sublimation from the liquid or suspension and partially or wholly sublimate. The liquid or suspension is also cooled through direct heat exchange with the cold carbon dioxide gas.

A wide variety of liquids or suspensions may be formed as particles according to the invention. A non-limiting list includes fats, oils, aqueous solutions of biomaterials, aqueous solutions of chemicals in solutes, suspensions of solid cosmetic additives in liquids, and solutions of pharmaceutical compounds.

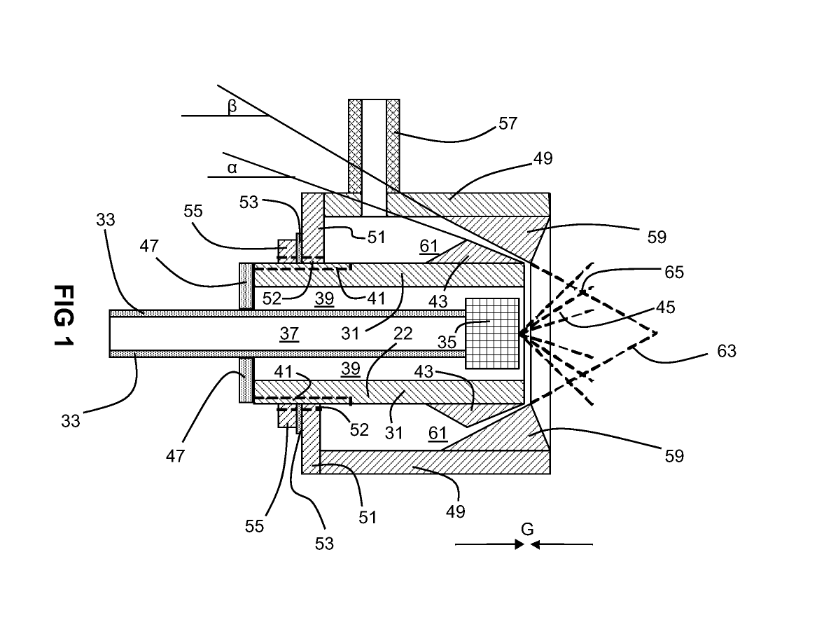

As best illustrated in FIG. 2, the spraying device 9 includes an atomization nozzle and a liquid cryogen housing.

The atomization nozzle includes an outer tube 31 separated by an insulating space 39 from an inner tube 33. The inner tube 33 forms a bore 37 in the atomization through which the liquid or suspension flows. The liquid or suspension exits the bore 37 at a spray nozzle 35 where it forms a diverging cone spray 45. The inner tube 33 is secured in a movable, yet fixed position with locknut 47.

The liquid cryogen housing includes a liquid cryogen inlet 57 that fluidly communicates with an annulus 61 defined between an inner surface of a cylindrical tube 49 and an outer surface of the outer tube 31. The cylindrical tube 49 of the liquid cryogen housing is threadedly engaged in fluid-tight fashion with the outer tube 31 via threading 41 on an outer surface of the outer tube 31 and threading 52 on an inner surface of a ring 51. The ring 51 is welded in fluid-tight fashion to the upstream end of the cylindrical tube 49 to prevent a flow of the liquid cryogen out the upstream end of the cylindrical tube 49 and annulus 61. A locknut 55 and gasket 53 further constrain movement of the liquid cryogen housing with respect to the atomization nozzle. The liquid cryogen exits the annulus 61 where it forms a converging cone spray 63 that contacts the diverging cone spray 45 at a ring-shaped intersection 65.

The outer tube 31 also includes an inner flange 43 that projects outwardly therefrom. Otherwise, the outer diameter of the outer tube 31 is constant from its upstream end to just upstream of the inner flange 43. At a position adjacent the downstream end of the outer tube 31, the outer diameter of the inner flange 43 decreases at an angle α with respect to the axis of the bore 37. The angle α is not limited, but rather is driven by the desired angle for the converging cone spray of liquid cryogen.

The cylindrical tube 49 also includes an outer flange 59 that projects inwardly therefrom. Otherwise, the inner diameter of the cylindrical tube 49 is constant from its upstream end to just upstream of the outer flange 59. At a position adjacent the downstream end of the cylindrical tube 49, the inner diameter of the outer flange 59 decreases at an angle β with respect to the axis of the bore 37. Similar to α, the angle β is driven by the desired angle for the converging cone spray of liquid cryogen.

The outer flange 59 and inner flange 43 cooperate to form a narrowing, converging portion in the annulus 61. As the liquid cryogen flows through the narrowing, converging portion, its linear speed accelerates to provide a high speed converging cone spray of liquid nitrogen.

The flow rate of the liquid cryogen out of the annulus 61 may be easily increased or decreased by correspondingly increasing or decreasing a gap G in between the inner and outer flanges 43, 59. The gap G may be adjusted by loosening or tightening the atomization nozzle on liquid cryogen housing via the threading 41, 52.

One aspect of the invention is the continuous annulus 61 which forms a continuous conical converging spray of liquid cryogen towards the diverging conical spray of the liquid or suspension. In contrast to prior art cryo-crystallization devices, the continuous annulus allows a greater uniformity of particle sizes. Thus, the particle size distribution is quite narrow. This is due to the fact that there are no gaps in the converging conical spray. In contrast, because prior art cryo-crystallization devices injects the liquid cryogen as a plurality of discrete streams towards the liquid or suspension, there are gaps in between the plurality of discrete streams.

When the prior art and the invention are compared in the above context, it is readily seen that there is more uniform mixing of the liquid cryogen and the liquid or suspension according to the invention. The more uniform mixing leads to greater uniformity in particle sizes.

In contrast, there is less uniform mixing of the liquid cryogen and the liquid or suspension in prior art devices (and greater non-uniformity of particle sizes), because portions of the diverging spray of the liquid or suspension do not contact the liquid cryogen in the gaps in between the discrete streams. Without being bound by any particular theory, it is believed that some portions (i.e., the first portion) of the liquid or suspension are immediately cooled and frozen by contact with the liquid cryogen while other portions (i.e., the second portion) are not immediately cooled and frozen. It is logical that this difference in cooling and freezing between the two portions will lead to larger particle sizes for the first portion as tiny droplets of unfrozen liquid or suspension accrete and freeze on the immediately formed “seed” particles (from the first portion). Because the second portion does not immediately provide “seed” particles upon which droplets of the liquid or suspension may accrete and freeze, when the droplets of the second portion do eventually freeze, they have a relatively smaller particle size.

Another aspect of the invention is the flexibility with which it may handle liquids or suspensions having different viscosities, flow rates, or thermal contents. Because of these differences, it may be desirable to modify the relative location of the ring-shaped intersection 65. In other words, it may be desirable to mix the cryogen and liquid or suspension at a more upstream point or a more downstream point. The relative location of the intersection 65 may be easily adjusted in the upstream or downstream direction by sliding the inner tube 33 and locknut 47 away from or towards the outer tube 31. In contrast, prior art cryo-crystallization devices fix the positions of the cryogen spray nozzle(s) and the spray nozzle(s) for the liquid or suspension. Thus, if it becomes important to adjust the relative location of the point at which the liquid cryogen and the liquid or suspension contact one another in a prior art device, the device must be disassembled and one or more different nozzles installed. This leads to production downtime.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method of producing particles from a liquid or suspension, said method comprising the steps of:
spraying the liquid or suspension from an atomization nozzle into a collection chamber as a diverging cone; and
spraying liquid cryogen from a continuous, converging annulus into the collection chamber as a converging cone, the diverging cone and the converging cone meeting at a ring-shaped intersection where droplets of the sprayed liquid are frozen into particles through heat exchange with the sprayed cryogen, the converging annulus being defined by the outer surface of the atomization nozzle and an inner surface of a liquid cryogen housing surrounding the atomization nozzle.

2. The method of claim 1, wherein the liquid cryogen is nitrogen or carbon dioxide.

3. The method of claim 1, further comprising the step of exhausting gaseous cryogen from the collection chamber into a cyclone separator where any of the particles that may have been carried over with the exhausted cryogen are separated from the exhausted cryogen.

4. The method of claim 1, further comprising the steps of:
collecting the frozen particles in a bottom portion of the collection chamber; and
periodically opening up a valve to release the frozen particles from the collection chamber.

5. The method of claim 4, further comprising the steps of:
exhausting gaseous cryogen from the collection chamber into a cyclone separator where any of the particles that may have been carried over with the exhausted cryogen are separated from the exhausted cryogen; and
collecting the separated particles at the bottom of the cyclone separator.

6. The method of claim 1, wherein the liquid or suspension comprises a molten fat.

7. The method of claim 1, wherein the liquid or suspension comprises an aqueous suspension of a biological material.

8. A system for producing particles from a liquid or suspension, comprising:
an atomization nozzle having an upstream end, a downstream end, and a centrally disposed bore extending through an axis of the nozzle, the bore converging at the downstream end of the nozzle for allowing a flow of the liquid or suspension to be sprayed therefrom as a diverging cone with an angle α to the bore axis;
a liquid cryogen housing surrounding the atomization nozzle having an upstream end and a downstream end, an outer surface of the atomization nozzle and an inner surface of the liquid cryogen housing defining a continuous annulus that converges towards the bore axis at the downstream end of the housing for allowing a flow of the liquid cryogen to be sprayed therefrom as a converging cone an angle β to the bore axis; and
a collection chamber for collecting frozen particles of the liquid or suspension that are formed at the intersection of the converging and diverging cones, wherein the downstream ends of the atomization nozzle and liquid cryogen housing fluidly communicate with an interior of the collection chamber.

9. The system of claim 8, wherein β-α ranges from 5° to about 40°.

10. The system of claim 8, wherein:
the atomization nozzle further comprising an inner flange disposed at a circumferential surface thereof at the nozzle downstream end that has an outer diameter that decreases towards the nozzle downstream end at the angle α; and
the liquid cryogen housing comprising a cylindrical tube concentric with the bore axis, a ring connected to the tube at the housing upstream end and to the outer surface of the atomization nozzle in fluid-tight fashion, and an outer flange disposed on an inner surface of the cylindrical tube adjacent the housing downstream end that is concentric with the bore axis and projects inwardly towards the inner flange, wherein:
an outer surface of the atomization nozzle is formed as a cylinder with an outer diameter that is constant from the nozzle upstream end to just upstream of the inner flange;
the cylindrical tube has a constant diameter from the ring to just upstream of the outer flange; and
the outer flange increasingly projects inwardly from upstream to downstream at the angle β.

11. The system of claim 8, further comprising a cyclone separator and an exhaust duct that fluidly communicates between an interior of the separator and an interior of the collection chamber for separating any frozen particles of the liquid or suspension that may have been carried over with exhausted cryogen to the separator from the collection chamber.

12. The system of claim 8, further comprising a tank of liquid cryogen and a container of the liquid or suspension to be frozen into particles.

13. The system of claim 8, further comprising a source of the liquid or suspension in fluid communication with the bore and a source of the liquid cryogen in fluid communication with the annulus.
